(19) United States
(12) Patent Application Publication
(10) Pub. No.: US 2016/0368121 A1
(43) Pub. Date: Dec. 22, 2016

(54) QUICK-OPERATING ADJUSTABLE WRENCH

(71) Applicant: Wei-Ming LAI, Taichung (TW)

(72) Inventor: Wei-Ming LAI, Taichung (TW)

(21) Appl. No.: 14/742,691

(22) Filed: Jun. 17, 2015

(51) Int. Cl. B25B 13/32; B25B 13/46

(52) U.S. Cl. CPC B25B 13/32; B25B 13/46

(57) ABSTRACT

A quick-operating adjustable wrench has a fixed jaw, a moveable jaw, and a handle. The fixed jaw has an abutting face, two mounting plates, and a mounting recess. The two mounting plates are formed on and protrude from the abutting face and are separate from each other, and the mounting recess is formed between the two mounting plates. The moveable jaw is pivotally connected to and abuts the fixed jaw, and has a pushing portion mounted in the mounting recess and abutting the fixed jaw. The handle is pivotally connected to the fixed jaw, abuts the movable jaw, and has a driving portion. The driving portion is pivotally connected to the fixed jaw and abuts the moveable jaw, and thereby the quick-operating adjustable wrench is applicable to nuts of different sizes. The structure of the quick-operating adjustable wrench is simplified, and may fasten fastening elements quickly.

### BACKGROUND OF THE INVENTION

1. Field of the Invention

The present invention relates to an adjustable wrench, and more particularly to a quick-operating adjustable wrench that can be used as a ratchet wrench and can be applied to fastening elements of different sizes.

2. Description of Related Art

A conventional adjustable wrench comprises a body, a fixed jaw, and a moveable jaw. The fixed jaw is formed on and protrudes from a top surface of the body and has a worm rod rotatably mounted in a bottom portion of the fixed jaw. The worm rod has an outer surface. The moveable jaw is moveably mounted on the top surface of the body and corresponding to the fixed jaw. The moveable jaw has a rack formed on a bottom portion of the movable jaw and engaging the worm rod of the fixed jaw. The moveable jaw is moved toward or away by rotating the worm rod of the fixed jaw, and an opening is formed between the fixed jaw and the moveable jaw. The moveable jaw is moved toward the fixed jaw by rotating the worm rod with a thumb of a user, which changes the width of the opening So the moveable and fixed jaws may clamp fastening elements, such as nuts or bolts, within the opening to fasten or loosen the fastening elements.

However, the width of the opening of the conventional adjustable wrench has to be adjusted again when the sizes of the fastening elements change. The outer surface of the worm rub is not smooth, such that user would have an uncomfortable feel when rotating the worm rob. The conventional adjustable wrench cannot be used to fasten or loosen the fastening elements repeatedly like a ratchet wrench, so it has to be removed from the fastening elements and clamps the fastening elements again in an environment with limited space. The conventional adjustable wrench takes a lot of time for operation and the efficiency is low.

To overcome the shortcomings of the conventional adjustable wrench, the present invention provides a quick-operating adjustable wrench to mitigate or obviate the aforementioned problems.

### SUMMARY OF THE INVENTION

The main objective of the present invention is to provide a quick-operating adjustable wrench which can be used as a ratchet wrench and can be applied to fastening elements of different sizes.

The quick-operating adjustable wrench has a fixed jaw, a moveable jaw, and a handle. The fixed jaw has an abutting face, two mounting plates, and a mounting recess. The two mounting plates are formed on and protrude from the abutting face and are separate from each other, and the mounting recess is formed between the two mounting plates. The moveable jaw is pivotally connected to and abuts the fixed jaw, and has a pushing portion mounted in the mounting recess and abutting the fixed jaw. The handle is pivotally connected to the fixed jaw, abuts the movable jaw and has a driving portion. The driving portion is pivotally connected to the fixed jaw and abuts the moveable jaw, and thereby the present invention is applicable for nuts of different sizes. The structure of the present invention is simplified, and may fasten or loosen fastening elements quickly.

Other objects, advantages, and novel features of the invention will become more apparent from the following detailed description when taken in conjunction with the accompanying drawing.

### BRIEF DESCRIPTION OF THE DRAWINGS

FIG. 1 is a perspective view of a first embodiment of a quick-operating adjustable wrench in accordance with the present invention;

FIG. 2 is a side view in partial section of the quick-operating adjustable wrench in FIG. 1;

FIG. 3 is an exploded perspective view of the quick-operating adjustable wrench in FIG. 1;

FIG. 4 is an operational side view in partial section of the quick-operating adjustable wrench in FIG. 1;

FIG. 5 is another operational side view in partial section of the quick-operating adjustable wrench in FIG. 1;

FIG. 6 is a perspective view of a second embodiment of a quick-operating adjustable wrench in accordance with the present invention;

FIG. 7 is a side view in partial section of the quick-operating adjustable wrench in FIG. 6;

FIG. 8 is an exploded perspective view of the quick-operating adjustable wrench in FIG. 6;

FIG. 9 is an operational side view in partial section of the quick-operating adjustable wrench in FIG. 6; and

FIG. 10 is another operational side view in partial section of the quick-operating adjustable wrench in FIG. 6.

### DETAILED DESCRIPTION OF PREFERRED EMBODIMENT

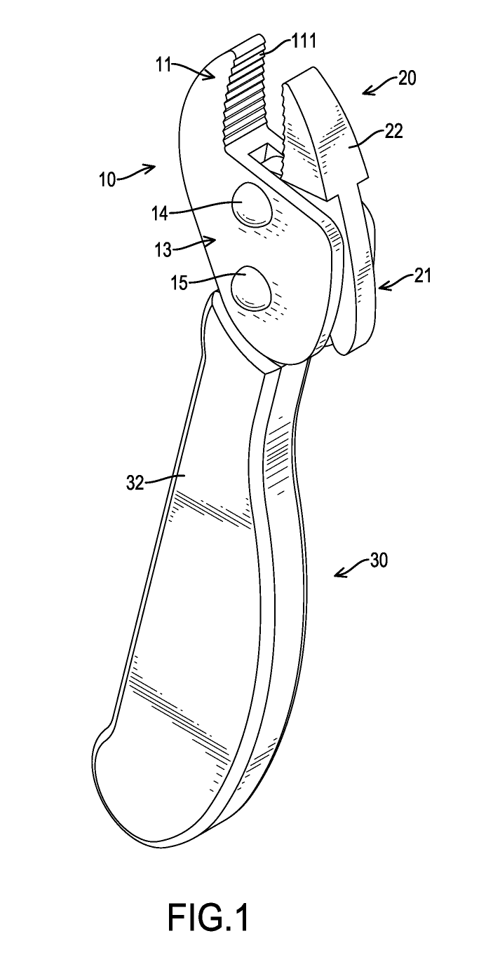

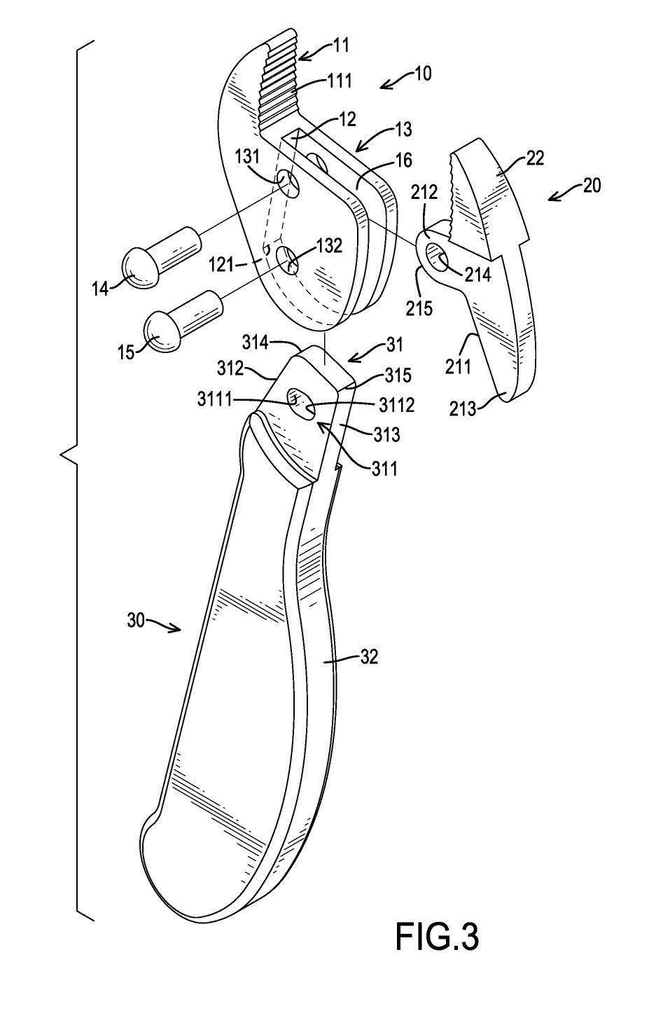

With reference to FIGS. 1 to 3, a first embodiment of a quick-operating adjustable wrench in accordance with the present invention comprises a fixed jaw 10, a moveable jaw 20, and a handle 30.

The fixed jaw 10 has a top surface, a side surface, a fixed portion 11, an abutting face 12, two mounting plates 13, a pivoting element 14, and a connecting element 15. The fixed portion 11 is formed on and protrudes upwardly from the top surface of the fixed jaw 10 and has an inner face and a clamping face 111. The clamping face 111 is formed on the inner face of the fixed portion 11. The clamping face 111 may clamp a nut and prevent the nut from slipping from the fixed portion 11 in use. The abutting face 12 is formed on the side surface of the fixed jaw 10 adjacent to the fixed portion 11 and has a bottom edge 121. The bottom edge 121 is opposite to the fixed portion 11 of the fixed jaw 10.

The two mounting plates 13 are formed on and protrude from the clamping face 111 of the fixed portion 11 away from the abutting face 12 of the fixed jaw 10. The two mounting plates 13 are separate from and parallel to each other, and each one of the mounting plates 13 has a pivoting hole 131 and a connecting hole 132. In addition, the fixed jaw 10 has a mounting recess 16 formed between the two mounting plates 13. The pivoting hole 131 is formed through the mounting plate 13 adjacent to the fixed portion 11 and communicates with the mounting recess 16. The two pivoting holes 131 of the two mounting plates 13 are aligned linearly. The connecting hole 132 is formed through the mounting plate 13 adjacent to the bottom edge 121 of the abutting face 12 and communicates with the mounting recess 16. The two connecting holes 132 of the two mounting plates 13 are aligned linearly.

The pivoting element 14 is mounted through the pivoting holes 131 of the two mounting plates 13. The connecting element 15 is mounted through the connecting holes 132 of the two mounting plates 13. Preferably, the pivoting element 14 and the connecting element 15 are rivets, such that both of the pivoting element 14 and the connecting element 15 are riveted together with the mounting plates 13.

The moveable jaw 20 is pivotally connected to and abuts the fixed jaw 10, and has a pushing portion 21 and a moveable portion 22. A part of the pushing portion 21 is mounted in the mounting recess 16 of the fixed jaw 10. Preferably, the pushing portion 21 is L-shaped and has a top surface, a bottom surface, an inner face, a pushing face 211, a proximal end 212, a distal end 213, a through hole 214, and a contact face 215.

The pushing face 211 is L-shaped and formed on the bottom surface of the pushing portion 21. The proximal end 212 faces the abutting face 12 of the fixed jaw 10. The distal end 213 is opposite to the proximal end 212. The through hole 214 is formed through the pushing portion 21 adjacent to the proximal end 212 and corresponding to the pivoting holes 131 of the two mounting plates 13. The through hole 214 communicates with the pivoting holes 131 of the two mounting plates 13. The pivoting element 14 is mounted through the through hole 214 and the pivoting holes 131 of the two mounting plates 13, and this enables the moveable jaw 20 to pivot on the pivoting element 14 and to rotate relative to the fixed jaw 10. The contact face 215 of the pushing portion 21 is arc-shaped, is formed on the inner face of the pushing portion 21 adjacent to the proximal end 212, and abuts the abutting face 12 of the fixed jaw 10.

The moveable portion 22 is formed on and protrudes upwardly from the top surface of pushing portion 21, and extends upwardly in the mounting recess 16 of the fixed jaw 10. The moveable jaw 20 may be rotated toward or away from the fixed jaw 10 by the pushing portion 21 that pivots on the fixed jaw 10. The contact face 215 of the pushing portion 21 continually abuts the abutting face 12 of the fixed jaw 10, which limits a rotating angle of the pushing portion 21 in a specific range. Accordingly, a distance between the moveable portion 22 of the moveable jaw 20 and the fixed portion 11 of the fixed jaw 10 remains in a specific range.

The handle 30 is pivotally connected to the fixed jaw 10, abuts the moveable jaw 20, and has a driving portion 31 and a lug portion 32. The driving portion 31 is a polygonal block and is mounted in the mounting recess 16 of the fixed jaw 10. Preferably, the driving portion 31 is a quadrilateral block and has a driving hole 311, a top surface, a contact face 312, a free face 313, and a bottom surface. The driving hole 311 is formed through the driving portion 31, is corresponding to the connecting holes 132 of the two mounting plates 13, and is adjacent to the bottom edge 121 of the abutting face 12.

Preferably, the driving hole 311 is a transversely elongated hole and has a proximal end 3111 and a distal end 3112. The proximal end 3111 is adjacent to the abutting face 12 of the fixed jaw 10. The distal end 3112 is opposite to the proximal end 3111. The connecting element 15 is mounted through the driving hole 311 and the connecting holes 132 of the two mounting plates 13, and this enables the driving portion 31 to pivot on the pivoting element 14 and to rotate relative to the fixed jaw 10.

The top surface of the driving portion 31 has a first edge 314 and a second edge 315, and the first edge 314 faces the abutting face 12 of the fixed jaw 10. The second edge 315 is opposite to the first edge 314 and abuts the pushing face 211 of the moveable jaw 20, and this enables the driving portion 31 to drive the moveable jaw 20 to rotate. The contact face 312 of the driving portion 31 faces the abutting face 12 of the fixed jaw 10 and abuts the bottom edge 121 of the abutting face 12. The free face 313 is opposite to the contact face 312 of the driving portion 31 and faces the distal end 213 of the pushing portion 21. The lug portion 32 is formed on and protrudes downwardly from the bottom surface of the driving portion 31, and extends downwardly in the mounting recess 16 of the fixed jaw 10.

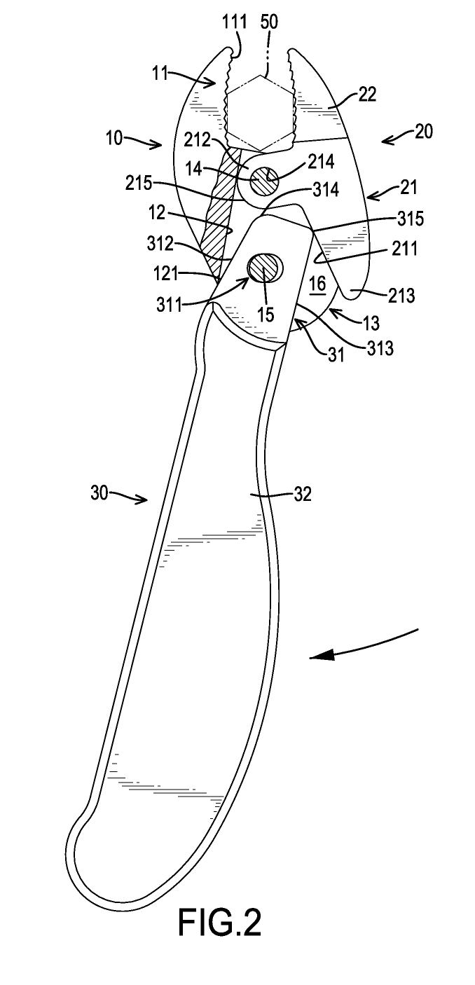

When the first embodiment of the present invention is in use, with reference to FIG. 2, a bolt 50 of small size is placed between the moveable portion 22 of the moveable jaw 20 and the fixed portion 11 of the fixed jaw 10. Users hold and rotate the lug portion 32 of the handle 30 in a clockwise direction, and this enables the driving portion 31 of the handle 30 to rotate in a clockwise direction. When the contact face 312 of the driving portion 31 abuts the bottom edge 121 of the abutting face 12, the connecting element 15 abuts the proximal end 3111 of the driving hole 311, and the second edge 315 of the driving portion 31 pushes the pushing face 211 of the moveable jaw 20. Therefore, the moveable jaw 20 rotates in a counterclockwise direction, and then the moveable portion 22 of the moveable jaw 20 and the fixed portion 11 of the fixed jaw 10 clamp the bolt 50, thereby fastening the bolt 50.

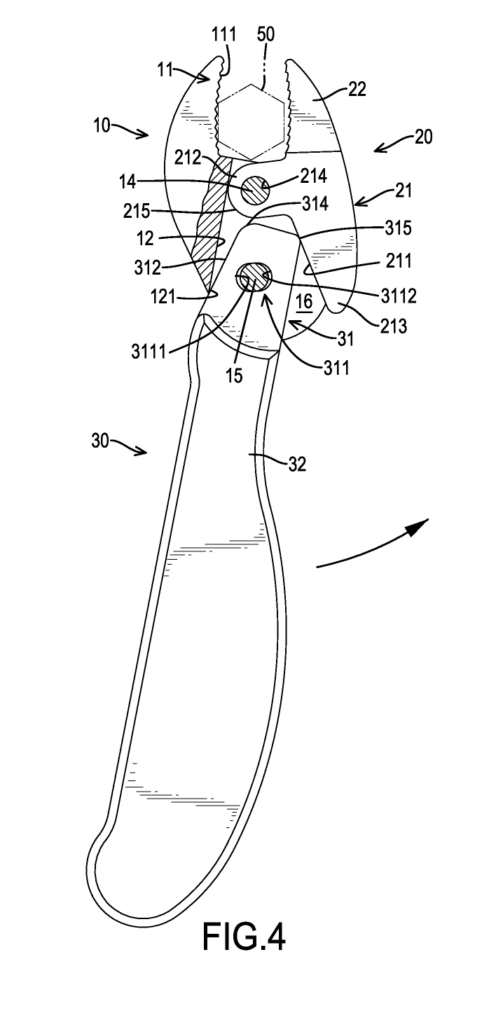

With reference to FIG. 4, when the first embodiment of the present invention is operated as a ratchet wrench to fasten the bolt 50 repeatedly, users hold and rotate the lug portion 32 of the handle 30 in a counterclockwise direction, and this enables the driving portion 31 of the handle 30 to rotate in a counterclockwise direction. Because the driving hole 311 is an elongated hole, the handle 30 moves toward or away the abutting face 12 of the fixed jaw 10 slightly. At the same time, a contact point between the second edge 315 of the driving portion 31 and the pushing face 211 of the pushing portion 21 moves upward slightly, and the bottom edge 121 slides on the contact face 312 of the driving portion 31 and continually abuts the contact face 312 of the driving portion 31. Accordingly, the moveable jaw 20 rotates in a clockwise direction, and a gap is formed between the moveable portion 22 of the moveable jaw 20 and the bolt 50. By repeating the operations as shown in FIGS. 2 and 4, the first embodiment of the present invention can fasten the bolt 50 of small size securely and conveniently.

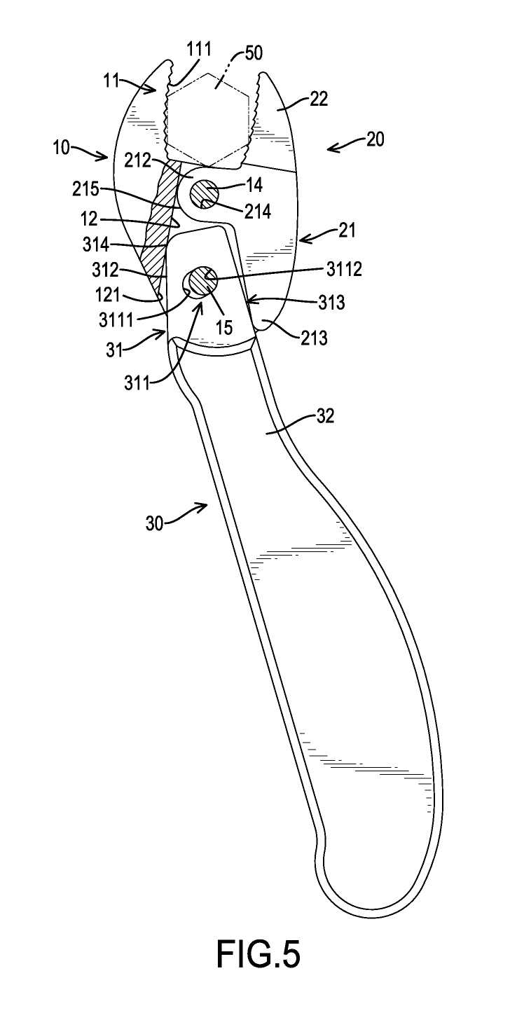

With reference to the FIG. 5, the first embodiment of the present invention is applied to a bolt 50 of large size. Users hold and rotate the lug portion 32 of the handle 30 in a counterclockwise direction, and this enables the driving portion 31 of the handle 30 to rotate in a counterclockwise direction. Because the connecting element 15 moves toward and abuts the distal end 3112 of the driving hole 311, the distal end 213 of the pushing portion 31 abuts the free face 313 of the driving portion 31, and the bottom edge 121 of the abutting face 12 abuts the contact face 312 of the driving portion 31. So the distance between the moveable portion 22 of the moveable jaw 20 and the fixed portion 11 of the fixed jaw 10 is enlarged, such that the present invention is applicable to a bolt 50 of large size.

The first embodiment of the quick-operating adjustable wrench in accordance with the present invention as described has the following advantage:

The moveable jaw 20 and the handle 30 are pivotally connected to the fixed jaw 10 and are partially mounted in the mounting recess 16, which makes the driving portion 31 abut the abutting face 12 of the fixed jaw 10. So the contact face 215 of the pushing portion 21 abuts the abutting face 12 of the fixed jaw 10 continually. The driving portion 31 of the handle 30 may push the moveable jaw 20, such that the moveable jaw 20 rotates relative to the fixed jaw 10. So the distance between the moveable portion 22 of the moveable jaw 20 and the fixed portion 11 of the fixed jaw 10 changes, such that the present invention may be operated as a ratchet wrench. The first embodiment of the present invention decreases the manufacturing cost and may be operated quickly.

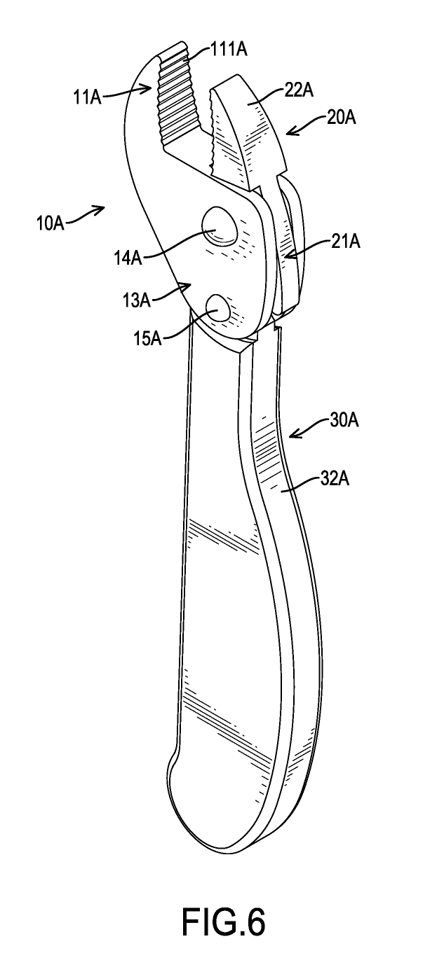

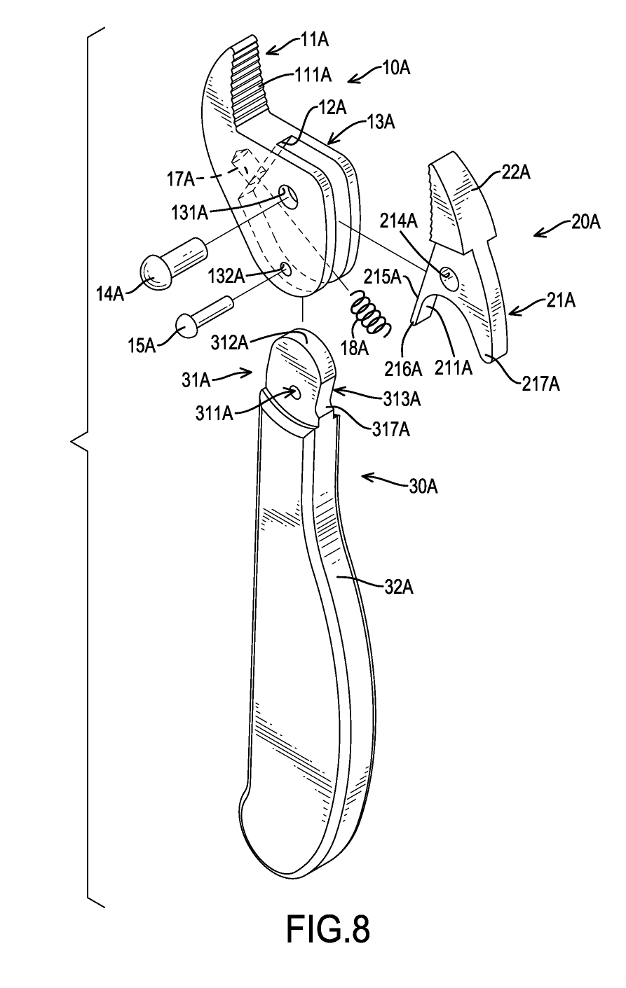

With reference to FIGS. 6 to 8, a second embodiment of a quick-operating adjustable wrench in accordance with the present invention is similar to the first embodiment, and the differences are: the fixed jaw 10A has a locating recess 17A and an elastic element 18A. The locating recess 17A is concaved toward the fixed portion 11A in the abutting face 12A. The elastic element 18A is mounted in the locating recess 17A and abuts the pushing portion 21A of the moveable jaw 20A. Preferably, the elastic element 18A is a spring.

The pushing portion 21A is inverted Y-shaped and has a bottom surface, a pushing face 211A, a contact face 215A, a first bottom end 216A, and a second bottom end 217A. The pushing face 211A is arc-shaped, is concaved upwardly in the bottom surface of the pushing portion 21A, and is opposite to the moveable portion 22A. The pushing face 211A has a right portion and a left portion. The contact face 215A of the pushing portion 21A faces the abutting face 12A of the fixed jaw 10A and abuts the elastic element 18A, and this enables the elastic element 18A to press the driving portion 31A of the handle 30 via the contact face 215A of the pushing portion 21A.The contact face 215A of the pushing portion 21A has a bottom end.

The first bottom end 216A is formed at the bottom end of the contact face 215A of the pushing portion 21A and is adjacent to the abutting face 12A. The second bottom end 217A is opposite to the first bottom end 216A. Preferably, the first bottom end 216A and the second bottom end 217A are arc-shaped. The driving portion 31A has a top surface, a contact face 312A, a free face 313A, and a limiting face 317A. The contact face 312A of the driving portion 31A is formed on the top surface of the driving portion 31A, and is corresponding to the pushing face 211A of the pushing portion 21A. The free face 313A faces the second bottom end 217A of the pushing portion 21A, and has a bottom end. The limiting face 317A is formed at a bottom of the free face 313A, and may abut the second bottom end 217A of the pushing portion 21A. The shape of the limiting face 317A is corresponding to the shape of the second bottom end 217A of the pushing portion 21A.

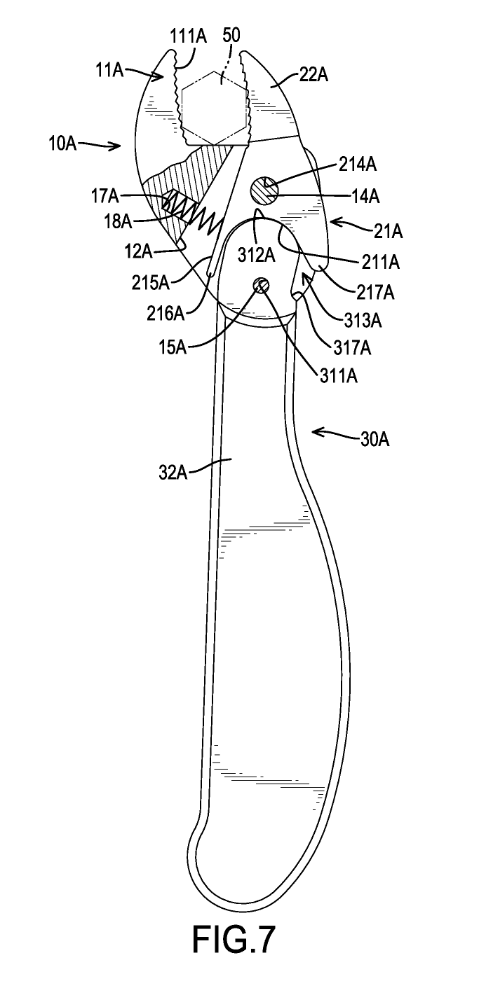

When the second embodiment of the present invention in use, with reference to FIG. 7, a bolt 50 of small size is placed between the moveable portion 22A of the moveable jaw 20A and the fixed portion 11A of the fixed jaw 10A. Users hold and rotate the lug portion 32A of the handle 30A in a clockwise direction, and this enables the driving portion 31A of the handle 30A to rotate in a clockwise direction. When the contact face 312A of the driving portion 31A pushes the right portion of the pushing face 211A of the pushing portion 21A, the moveable jaw 20A rotates in a counterclockwise direction relative to the fixed jaw 10A, and the moveable portion 22A of the moveable jaw 20A and the fixed portion 11A of the fixed jaw 10A clamp the bolt 50, thereby fastening the bolt 50. During the operating process, the elastic element 18A of the fixed jaw 10A continually abuts the contact face 215A of the moveable jaw 20A. Thus the moveable jaw 20A remains stable relative to the fixed jaw 10A.

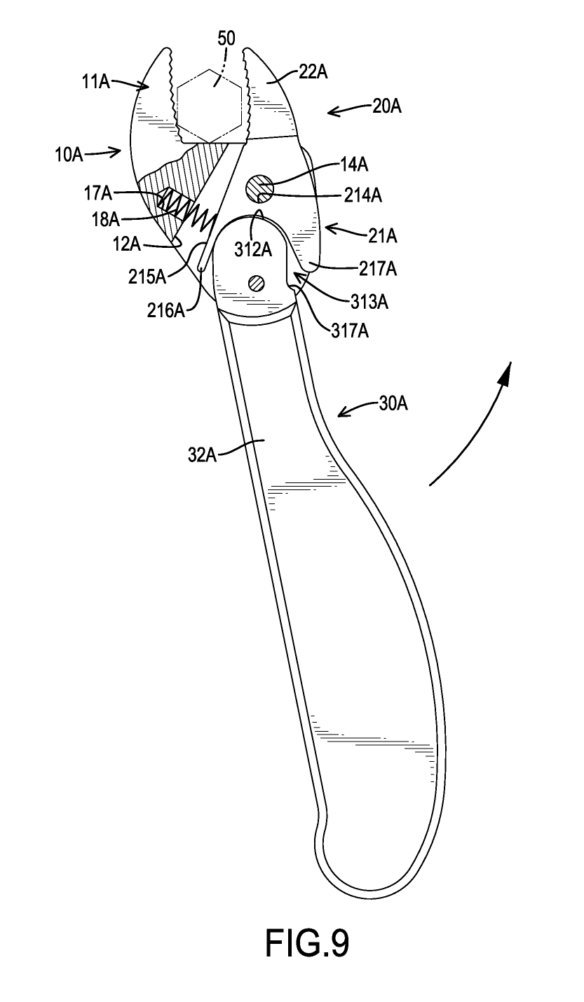

With reference to FIG. 9, when the second embodiment of the present invention is operated as a ratchet wrench to fasten the bolt 50 repeatedly, users hold and rotate the lug portion 32A of the handle 30A in a counterclockwise direction, and this enables the driving portion 31A of the handle 30A to rotate in a counterclockwise direction slightly. One thumb of the user presses the second bottom end 217A of the pushing portion 21A toward the limiting face 317A of the driving portion 31A, making the contact face 215A of the pushing portion 21A compress the elastic element 18A. Accordingly, the moveable jaw 20A rotates in a clockwise direction, and a gap is formed between the moveable portion 22A of the moveable jaw 20A and the bolt 50. By repeating the operations as shown in FIGS. 7 and 9, the second embodiment of the present invention can fasten the bolt 50 of small size securely.

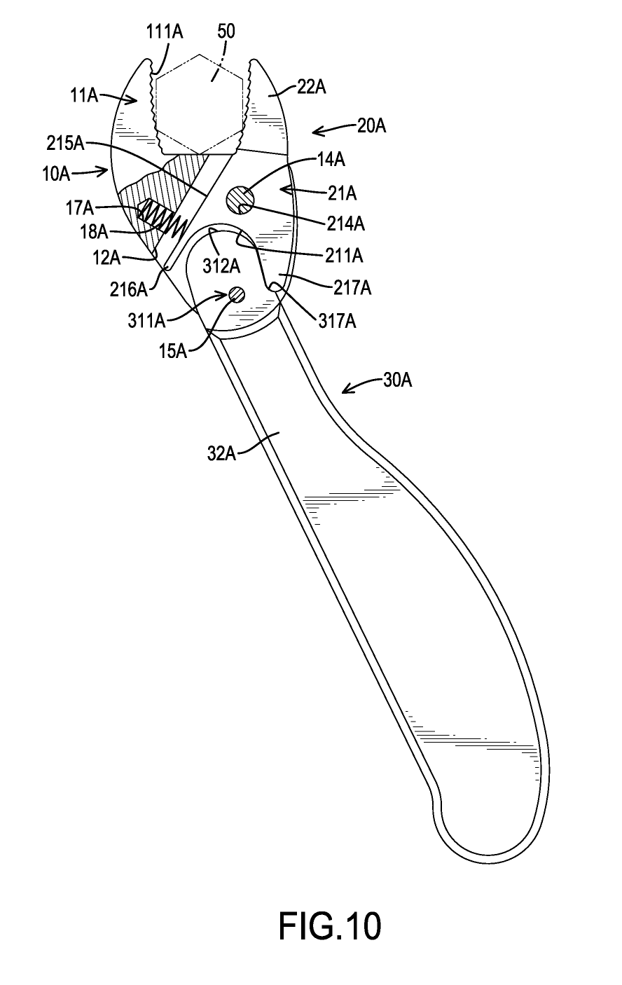

With reference to the FIG. 10, the second embodiment of the present invention is applied to a bolt 50 of large size. Users hold and rotate the lug portion 32A of the handle 30A in a counterclockwise direction, and this enables the driving portion 31A of the handle 30A to rotate in a counterclockwise direction. One thumb of the user presses the second bottom end 217A of the pushing portion 21A toward the limiting face 317A of the driving portion 31A, making the contact face 215A of the pushing portion 21A compress the elastic element 18A more deeply compared with FIG. 9. At the same time, the moveable jaw 20A rotates in a clockwise direction, and then the second bottom end 217A of the pushing portion 21A abuts the limiting face 317A of the driving portion 31A. So the distance between the moveable portion 22A of the moveable jaw 20A and fixed portion 11A of the fixed jaw 10A is enlarged, such that the present invention is applicable to a bolt 50 of large size.

The second embodiment of the quick-operating adjustable wrench in accordance with the present invention as described has the following advantages:

The pushing portion 21A is inverted Y-shaped, and the pushing face 211A is arc-shaped and is concaved upwardly in the bottom surface of the pushing portion 21A. The contact face 312A of the driving portion 31A matches the pushing face 211A, and this enables the driving portion 31A to abut the pushing portion 21A smoothly, such that the present invention may be operated smoothly. Because the elastic element 18A presses the contact face 215A of the pushing portion 21A continually, the moveable jaw 20A remains stable relative to the fixed jaw 10A. Thus the quick-operating adjustable wrench can be applied to bolts 50 of different sizes and operated more smoothly and more efficiently, and the structure of the quick-operating adjustable wrench is simplified.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A quick-operating adjustable wrench comprising:
a fixed jaw having
a top surface;
a side surface;
a fixed portion formed on and protruding upwardly from the top surface of the fixed jaw, and having
an inner face; and
a clamping face formed on the inner face of the fixed portion; and
an abutting face formed on the side surface of the fixed jaw adjacent to the fixed portion and having
a bottom edge being opposite to the fixed portion of the fixed jaw;
two mounting plates formed on and protruding from the clamping face of the fixed portion away from the abutting face of the fixed jaw, and being separate from and parallel to each other, a mounting recess formed between the two mounting plates, and each one of the mounting plates having
a pivoting hole formed through the mounting plate adjacent to the fixed portion and communicating with the mounting recess, and the two pivoting holes of the two mounting plates aligned linearly; and
a connecting hole formed through the mounting plate adjacent to the bottom edge and communicating with the mounting recess, and the two connecting holes of the two mounting plates aligned linearly;
a pivoting element mounted through the pivoting holes of the two mounting plates;
a connecting element mounted through the connecting holes of the two mounting plates; and
a moveable jaw pivotally connected to and abutting the fixed jaw, and comprising
a pushing portion mounted in the mounting recess of the fixed jaw, abutting the fixed jaw, and having
a top surface;
a bottom surface;
an inner face;
a pushing face formed on the bottom surface of the pushing portion; and
a through hole formed through the pushing portion and corresponding to the pivoting holes of the two mounting plates, the pivoting element mounted through the through hole; and
a moveable portion formed on and protruding upwardly from the top surface of the pushing portion and extending upwardly in the mounting recess of the fixed jaw; and
a handle pivotally connected to the fixed jaw, abutting the moveable jaw, and having
a driving portion mounted in the mounting recess of the fixed jaw, abutting the abutting face of the fixed jaw, and having
a driving hole formed through the driving portion and corresponding to the connecting holes of the two mounting plates adjacent to the bottom edge of the abutting face, the connecting element mounted through the driving hole;
a top surface abutting the pushing face of the pushing portion; and
a bottom surface; and
a lug portion formed on and protruding downwardly from the bottom surface of the driving portion and extending downwardly in the mounting recess of the fixed jaw.

2. The quick-operating adjustable wrench as claimed in claim 1, wherein the pushing portion is L-shaped and has a proximal end abutting the abutting face, a distal end opposite to the proximal end, and a contact face formed on the inner face adjacent to the proximal end and abutting the abutting face, the through hole being adjacent to the proximal end, the driving portion being a polygonal block, the top surface of the driving portion having a first edge facing the abutting face and a second edge opposite to the first edge and abutting the pushing face of the moveable jaw.

3. The quick-operating adjustable wrench as claimed in claim 2, wherein the contact face of the pushing portion is arc-shaped.

4. The quick-operating adjustable wrench as claimed in claim 3, wherein the driving portion is a quadrilateral block.

5. The quick-operating adjustable wrench as claimed in claim 1, wherein the driving hole is a transversely elongated hole.

6. The quick-operating adjustable wrench as claimed in claim 2, wherein the driving hole is a transversely elongated hole.

7. The quick-operating adjustable wrench as claimed in claim 3, wherein the driving hole is a transversely elongated hole.

8. The quick-operating adjustable wrench as claimed in claim 4, wherein the driving hole is a transversely elongated hole.

9. The quick-operating adjustable wrench as claimed in claim 1, wherein
the pushing portion is inverted Y-shaped and has
a contact face;
a first bottom end; and
a second bottom end;
the pushing face is arc-shaped and is concaved upwardly in the bottom surface of the pushing portion; and
the driving portion has
a contact face formed on the top surface and corresponding to the pushing face of the pushing portion;
a free face facing the second end of the pushing portion; and
a limiting face formed at a bottom of the free face, and having a shape corresponding to a shape of the second bottom end of the pushing portion.

10. The quick-operating adjustable wrench as claimed in claim 9, wherein the first bottom end and the second bottom end are arc-shaped.

11. The quick-operating adjustable wrench as claimed in claim 10, wherein
the fixed jaw has
a locating recess concaved toward the fixed portion in the abutting face; and
an elastic element mounted in the locating recess and abutting the pushing portion of the moveable jaw;
the contact face of the pushing portion faces the abutting face of the fixed jaw and abuts the elastic element; and
the elastic element abuts the driving portion of the handle via the contact face of the pushing portion of the moveable jaw.
